(19) United States
(12) Patent Application Publication
(10) Pub. No.: US 2019/0392162 A1
(43) Pub. Date: Dec. 26, 2019

(54) DYNAMIC CONSENT ENFORCEMENT FOR INTERNET OF THINGS

(71) Applicant: Merck Sharp & Dohme Corp., Rahway, NJ (US)

(72) Inventors: Hal Stern, Livingston, NJ (US); James Nunzio Ciriello, Madison, NJ (US)

(21) Appl. No.: 16/017,281

(22) Filed: Jun. 25, 2018

(51) Int. Cl. G06F 21/62; G06F 17/30

(52) U.S. Cl. CPC G06F 21/6218; G06F 17/30864

(57) ABSTRACT

A verification system enforces consent verifications on attempts to forward data collected by wireless devices associated with users of the verification system. Responsive to receiving a request from a third-party system to access personal data associated with a user, the verification system determines a required level of user consent based on the type of requested data and queries a permissions data store to determine whether the user has provided the required level of consent. If a consent verification obtained from the user permits disclosure of the requested data at the required level of consent, the verification system instructs the wireless device to send the data to the third-party system. Conversely, if no active consent verification permits disclosure, the verification system sends a consent request to the user via a client device prompting the user to authorize disclosure of the requested data to the third-party system.

### TECHNICAL FIELD

The disclosure generally relates to the field of obtaining consent to share, and in particular to enforcing consent verifications for requests to access data collected by Internet-of-Things devices.

### BACKGROUND

It is not uncommon for an individual to be associated with several personal devices, each of which may collect one or more types of data about the individual, such as her current location and location history, information about her medical status and fitness level, her online browsing history, and her interactions and connections on social networking sites. While these devices may allow the individual to easily share collected data with her friends, family members, and healthcare professionals, security and privacy concerns abound. Insufficient security protocols may risk disclosure of sensitive personal data to unauthorized third parties, who may use the data for malicious purposes.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

Figure (FIG. 1 illustrates an example networked computing environment in which a verification system operates, according to one embodiment.

FIG. 2 illustrates a block diagram of the verification system for use in the networked computing environment of FIG. 1, according to one embodiment.

FIG. 3 illustrates an interaction diagram for obtaining consent verifications associated with data collected by an Internet-of-Things (“IoT”) device, according to one embodiment.

FIG. 4 illustrates an interaction diagram for processing requests from third-party systems to access data collected by an IoT device, according to one embodiment.

FIG. 5 is a block diagram illustrating components of an example machine able to read instructions from a machine-readable medium and execute them in a processor (or controller), according to one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

In many contexts, the ability to share personal data is valuable. For example, in the health field, doctors may wish to access medical data collected via wearable technology, such as heart rate or blood pressure monitors, to determine an appropriate course of treatment for their patients. As another example, users of wearable fitness technology might want to share their workout accomplishments with their coaches through a third-party application or their friends on a social networking system. To prevent unauthorized collection of personal health information and other data, users may need to grant third parties permission to access the data collected by their wearable devices. However, these devices are controlled by third-parties and often have fixed or limited user interfaces, making it difficult or impossible for the user to consent to data-sharing on the device itself.

Disclosed by way of example embodiment is a configuration that may include a method (and/or corresponding system and computer-readable medium storing instructions executable by one or more processors) for enforcing consent for sharing data collected by internet of things devices. An example configuration may include storing personal data collected or to be collected by IoT devices associated with users of a computer system and consent verifications associated with the stored personal data. Consent verifications are data and service-specific and govern the conditions under which the personal data may be shared with a requesting service. Example components of the consent verification include a type of personal data that may be shared with a requesting service, a window of time or specified times at which the data may be shared, whether the data may be shared continuously or whether each instance of data sharing requires a new consent verification, a level of granularity at which the data may be shared, types of data that may not be shared with the requesting service, a time at which consent to share data was provided, a time at which the consent verification expires, and information about the IoT device, including the device model, how the personal data is collected, and security protocols associated with the IoT device. For example, a consent verification for a heart monitor associated with a first user may specify that data regarding the first user's heart rate, including the beats per minute (BPM) recorded during intervals of rest and exercise, may be shared with a third-party service associated with the user's doctor for the next month. The consent verification may further specify that consent was provided by the user at a first time on a first date and will expire at a second time on a second date unless the user consents to continued data sharing. Additional parameters associated with the consent verification may include data about the heart monitor itself and how the heart rate data is collected (e.g., via electrode pads with transmitters attached to straps worn around the user's chest).

The heart rate data collected by the heart monitor may be stored in association with the consent verification. Responsive to receiving a request from a third-party system to access the personal data collected by the IoT device, the verification system determines a level and type of consent required to share the requested data and analyzes consent verifications permitting disclosure of the requested data with the third-party system. If the verification system determines that the level and type of data requested is within the scope of one or more consent verifications associated with the collected data, the verification system authorizes the IoT device to share the requested data with the third-party system. Conversely, if the verification system determines that the user has not consented to sharing collected personal data with the third-party system, that the consent verification associated with the collected data is expired, and/or that the level and type of data requested is not within the scope of an existing consent verification, the verification system sends a consent request to the user's client device to prompt the user to grant or deny consent for the data sharing. Responsive to the user creating a new consent verification or updating an existing verification that permits the sharing of the requested data with the third-party system, the verification system authorizes the IoT device to share the requested data consistent with the terms of the consent verification.

Consent verifications associated with collected data and attempts to access the data may be appended to a distributed ledger (e.g., a blockchain). Because data that has been anchored to the distributed ledger is exceedingly difficult to modify, the appended consent verification and access attempts may be used to ensure that every recorded access on the distributed ledger complies with the consent requirements stored on the distributed ledger for the same time period.

### Example Computing Environment

FIG. 1 illustrates an example embodiment of a networked computing environment 100 in which consent verification may be provided. In the embodiment shown, the networked computing environment 100 includes a client device 110 and one or more IoT devices 120 in communication with a verification system 150 and a third party system 140 through a network 130.

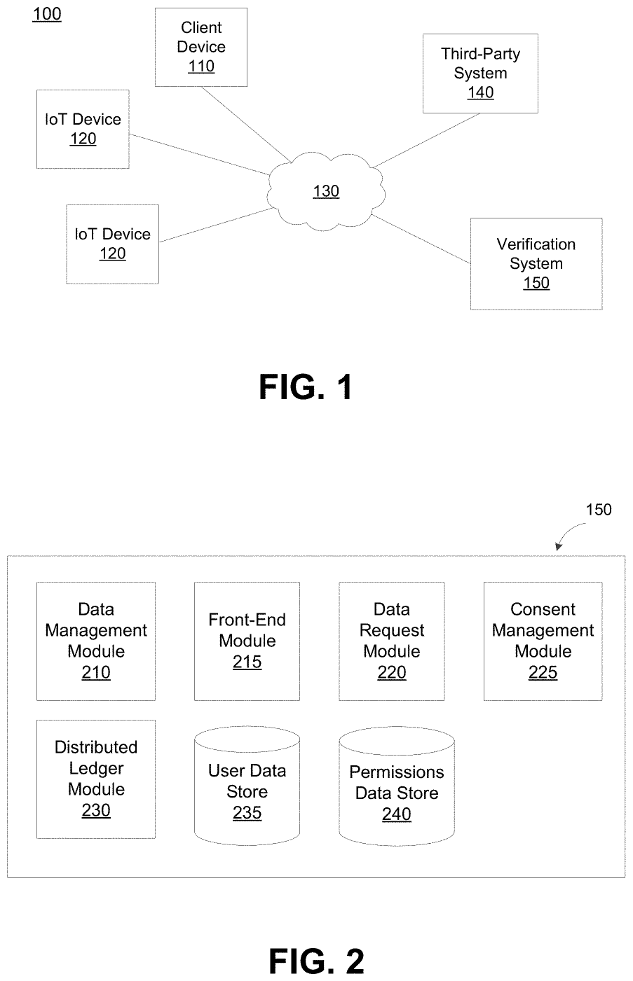

The verification system 150 stores and manages consent verifications associated with data collected by the IoT devices 120. Users may register IoT devices 120 with the verification system 150 and dictate the conditions under which personal data collected by the IoT devices 120 may be shared with third-party systems 140. Responsive to receiving a request from a third-party system 140 to access personal data collected by an IoT device 120 associated with a first user, the verification system 150 determines whether the requested data is associated with one or more existing consent verifications and, if so, whether the applicable terms permit sharing the collected data according to the terms of the request. If the verification system 150 determines that one or more consent verification permit disclosure to the third-party system 140 of the requested data, the verification system 150 authorizes the IoT device 120 to send the data to the third-party system 140. If, however, the verification system 150 determines that the requested data does not fall within the scope of an existing consent verification, that an existing consent verification for the data does not permit disclosure of the data to the third-party system 140 or pursuant to the terms of the request, and/or that an existing consent verification has expired or must otherwise be updated, the verification system 150 sends a consent request to the user via the client device 110, prompting the user to accept or deny the third party system's data request. In some embodiments, registration of a consent verification may be coupled to existing registration mechanisms, for example, patient data entry in an electronic medical record system that collects phone numbers, establishing a two-factor authentication mechanism for the requested information. Various embodiments of the verification system 150 are described in greater detail below, with reference to FIG. 2.

The client device 110 is a computing device capable of receiving user input as well as transmitting and/or receiving data via the network 130. In one embodiment, the client device 110 is a conventional computer system, such as a desktop or laptop computer. Alternatively, the client device 110 may be a device having computer functionality, such as a personal digital assistant (PDA), a mobile telephone, a smartphone, a set-top box, a smart home device, or another suitable device.

In one embodiment, the client device 110 executes an application allowing a user of the client device 110 to interact with the verification system 150. For example, the client device 110 executes a browser application to enable interaction between the client device 110 and the verification system 150 via the network 130. In another embodiment, the client device 110 interacts with the verification system 150 through an application programming interface (API) running on a native operating system of the client device 110, such as IOS® or ANDROID™.

Client devices 110 may be paired with one or more Internet-of-things (“IoT”) devices 120 that collect personal data associated with a user. The association between a client device 110 and the paired IoT devices 120 may be provided by a user through the client device 110 and stored in a user data store 235 on the verification system 150. In one embodiment, the user data store 235 stores information about the client device 110, including the manufacturer and model of the device and a preferred method of contacting the user via the client device 110 (e.g., via phone call or SMS message at a phone number associated with the client device 110).

The IoT device 120 is a computing device capable of receiving user input as well as transmitting and/or receiving data via the network 130. In one embodiment, the IoT device 120 is a wearable computing device, such as a health monitoring device or a fitness device, that collects personal data from the wearer. Example health and fitness data collected by the IoT device 120 may include activity logs, heart rate, blood pressure, step count, temperature, calories burned, and sleep data (e.g., when the user falls asleep and wakes up and how long the user was in various states of sleep). Additionally or alternatively, the IoT device 120 may use location services to determine a user's geographic location and may include recording capabilities that allow the user to record voice data for personal use and/or to share with third-party systems 140. In other embodiments, the IoT devices 120 may include other types of computing devices, such as personal digital assistants (PDAs), mobile telephones, smartphones, and another suitable devices.

The IoT device 120 may have a user interface that allows the user to provide input and view data received and/or collected by the IoT device 120. For example, the user interface may include a first portion displaying the user's heart rate and a second portion allowing the user to provide input comprising an instruction to share the heart rate data with a third-party system. In alternate configurations, the IoT device 120 has a limited user interface such that the screen size precludes or inhibits the user's ability to provide input corresponding to the collected data. In still other embodiments, the IoT device 120 does not have a user interface. In some embodiments, the IoT device 120 records data on removable media, such as flash drives, memory cards, or external hard disk drives, that may be connected to a client device, such as a desktop or laptop computer, associated with the third-party system 140.

Data collected by the IoT device 120 is sent to the verification system 150 through the network 130 for storage in the user data store 235. In one embodiment, collected data is sent to the verification system 150 in real-time. Alternatively, the collected data may be batched and sent to the verification system at periodic intervals (e.g., every 30 seconds, every 2 minutes, etc.).

The network 130 may comprise any combination of local area and/or wide area networks, using both wired and/or wireless communication systems. In one embodiment, the network 130 uses standard communications technologies and protocols. For example, the network 130 includes communications links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 130 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 130 may be represented using any suitable format, such as hypertext markup language (HTML) or extensible markup language (XML). In some embodiments, all or some of the communications links of the network 130 may be encrypted using any suitable technique or techniques. While in the embodiment shown in FIG. 1, the client device 110, the IoT devices 120, the third-party system 140, and the verification system 150 exchange data through a single network 130, in other example embodiments (not shown in FIG. 1), the network between the client device 110 and the IoT devices 120 is a set of networks or a proximity network such as Zigbee, Bluetooth, or RFID. For example, the IoT devices 120 might communicate with the client device 110 through a proximity network, such that the client device 110 acts as a gateway or proxy to the network 130.

One or more third-party systems 140 are coupled to the network 130 for communicating with the verification system 150, which is further described below in connection with FIG. 2. In one embodiment, a third-party system 140 is an application provider communicating information describing applications for execution by the client device 110 or an associated IoT device 120 or communicating to the client device 110 for use by an application executing on the client device 110 or the IoT device 120. In other embodiments, the third-party system 140 provides content or other information for presentation via the client device 110 and/or requests access to content or other information from the client device 110 or the IoT device 120. For example, a third-party system 140 may be associated with a doctor's office that wishes to track health and fitness data collected by IoT devices 120 associated with patients.

### Example Verification System

FIG. 2 is a block diagram of a verification system 150 for use in the networked computer environment 100, according to one embodiment. The verification system 150 shown in FIG. 2 includes a data management module 210, a front-end module 215, a data request module 220, a consent management module 225, a distributed ledger module 230, a user data store 235, and a permissions data store 240. In other embodiments, the verification system 150 may include additional, fewer, or different components for various applications. In addition, the functions may be distributed among the components in a different manner than described. Conventional components such as network interfaces, security functions, load balancers, failover servers, management and network operations consoles, and the like are not shown so as to not obscure the details of the system architecture.

The user data store 235 includes one or more computer readable media configured to store user data. In FIG. 2, the user data store 235 is shown as part of the verification system 150. However, the user data store 235 may also be a separate component from the verification system 150, connected via a network. Further, although the user data store 235 is shown as a single entity, it may be distributed across several computing devices that are connected via a network. Users may interact with the verification system 150 through the data management module 210 to provide and update user profile and device information.

In one embodiment, each user of the verification system 150 is associated with a user profile, which is stored in a user data store 235. A user profile includes declarative information about the user that was explicitly shared by the user and may also include profile information inferred by the verification system 150. In one embodiment, a user profile includes multiple data fields, each describing one or more attributes of the corresponding verification system user. Examples of information stored in a user profile include biographic, demographic, and other types of descriptive information, such as gender, hobbies or preferences, location, and the like. A user profile may also store information about client devices 110 and IoT devices 120 associated with the user. For example, a user profile might indicate that a user of the verification system 150 is associated with a first client device 110 and two IoT devices 120: a wearable fitness tracking device that monitors the user's activity (e.g., number of steps taken, number of calories burned, etc.) and a combined medical monitoring device that allows the user to take basic vital measurements, such as temperature, pulse, oxygen saturation, and blood pressure, and so on.

The data management module 210 receives data collected by IoT devices 120 associated with users of the verification system 150 and sends the received data to the permissions data store 240 for storage. Received data is stored in association with the user's user profile and may be subject to one or more consent verification(s) that dictate the terms by which the received data may be shared with third-party systems 140. For example, a consent verification for data collected by a combined medical monitoring device might specify that certain types of information (e.g., physical activity, sleep data) may be shared with a specified third-party system 140, but that other types of data collected by the device (e.g., temperature, pulse, blood pressure) may not be shared. In some embodiments, the data management module 210 also receives one or more user-specified parameters that govern the general conditions under which collected data may be stored by the verification system 150 and/or shared with third-party systems 140. For example, a user-specified parameter might dictate that the data may be stored by the verification 150 for a specified period of time before deletion or that sleep data may be shared with third-party systems 140 while blood pressure data may not be. The data management module 210 sends the received user-specified parameters to the user data store 235 for storage. The front-end module 215 facilitates communication between the verification system 150 and third-party systems 140. In one embodiment, the front-end module 215 receives requests from third-party systems 140 to access personal data associated with a user and collected by the IoT devices 120. In one embodiment, the third-party system request includes at least an identification of the third-party system 140, an identification of the user, an identification of the IoT device 120, and a description of the requested data including the type of data (e.g., blood pressure measurements) and a data window (e.g., measurements collected at specified times over the past month or to be collected in the next week or when the IoT device 120 is in a specified location). For example, the third-party system 140 may request access to data collected by the IoT device 120 when the IoT device 120 and the associated user are in the provider's office. While data collected at the specified time and/or at the specified location may be authorized by the consent verification, the verification system 150 will not permit the third-party system 140 to access multiple location data items collected over time (e.g., speed, previous location, and other data that might be used to identify a user).

Responsive to receiving a data access request from a third-party system 140, the front-end module 215 instructs the data request module 220 to process the third-party system requests by determining whether the requested information may be shared pursuant to the terms of consent verifications. Specifically, the front-end module 215 instructs the data request module 220 to query the permissions data store 240 to determine whether any consent verifications govern the disclosure of the user's data to the requesting third-party system 140, as discussed below.

Responsive to the data request module 220 determining that some or all of the collected information may be disclosed to the requesting third-party system 140 according to the terms of one or more consent verifications, the front-end module 215 authorizes the IoT device(s) 120 to send the requested data to the third-party system 140. Alternatively, the front-end module 215 may query the user data store 235 for the requested data and send the received data to the third-party system 140. In some embodiments, the requested data is encrypted or otherwise concealed before being sent to the third-party system 140.

In some embodiments, data collected by the IoT device 120 is encrypted and recorded on removable media, such that connection of the removable media to a client device, such as a desktop or laptop computer associated with the third-party system 140, prompts the verification system to initiate the consent verification method. For example, the IoT device 120 might be a Continuous Positive Airway Pressure (CPAP) machine, which records data on a secure digital (SD) card. Insertion of the card into a provider's computer acts as a request to the front-end module 215 to access the data on the SD card, prompting the front-end module 215 to instruct the data request module 220 to query the permissions data store 240 for one or more consent verifications that would permit sharing the data on the SD card with the provider.

The data request module 220 receives instructions from the front-end module 215 to determine whether the requested data may be shared with one or more third-party systems 140 pursuant to the terms of one or more consent verifications. In one embodiment, the data request module 220 queries a consent management module 225, which determines the level and type of consent required to disclose the requested data to the third-party system and queries the permissions data store 240 to determine whether the required consent has been provided by the user. In one embodiment, a level of consent is directly proportional to a level of sensitivity of the collected data and indicates how rigorous consent collection should be, while a type of consent indicates one or more acceptable methods by which to obtain consent from the user based on the assigned level of consent. For example, for less sensitive data (e.g., data from a user's fitness tracker that shows how far a user ran and his mile time as part of a marathon training program), the consent management module 225 assigns a lower consent level such that the user's consent to share the collected data with a third-party system 140 (e.g., the user's coach) may be obtained via a simple method (e.g., yes/no response, user-specific PIN). By contrast, if the consent management module 225 determines that the requested data is highly sensitive (e.g., medical data such as the user's heart rate, oxygen saturation, blood pressure, etc.), the consent management module 225 may assign a higher level of consent, prompting the verification system 150 to use heighted measures, such as biometric identification, to obtain authorization from the user. Further, in embodiments where the client device 110 is a set top box, smartphone, smart home device, or other device with voice recognition capability, consent may be obtained from the user via voice command. For example, the verification system 150 may instruct the client device 110 to query the user “Your doctor would like to access your location information. You don't normally share this information with your doctor? Would you like to share it?”

Responsive to determining the level and type of consent required to allow the third-party system 140 to access the requested data, the data request module 220 queries the permissions data store 240 for any permissions associated with the requested data. Specifically, the data request module 220 determines whether the user has provided one or more consent verifications that match the level and type of consent required to access the requested data and that authorize the verification system 150 to disclose the requested data to the third-party system 140. In some embodiments, multiple consent verifications may be associated with a third-party system access request. For example, a user's doctor might wish to access heart rate and blood pressure data collected by a combined medical monitoring device and blood glucose data collected by an insulin pump. Responsive to receiving the access request, the data request module 220 will query the permissions data store 240 to determine whether the user has provided consent verifications allowing the doctor to access data from both IoT devices 120. As another example, a user training for a marathon may wish to share his activity data with his physical therapist as well as his running coach. If third-party systems 140 associated with both data recipients request access to the data, the data request module 220 will query the permissions data store 240 to determine whether the user has provided a first consent verification authorizing the physical therapist to access the collected data and a second consent verification permitting the user's doctor to do the same. Alternatively, a single consent verification may permit disclosure to both data recipients. In some embodiments, a consent verification may limit the number of times that data collected by the IoT devices 120 may be forwarded by the verification system 150 or a third-party system 140. For example, a user might limit the disclosure of data to a single “hop” such that while data collected by her IoT device 120 may be shared with her primary care physician, the physician may not forward the collected data to a specialist. As another example, a user might limit data forwarding to three different providers such that subsequent attempts to forward the data will prompt the verification system 150 to send an additional consent request to the user.

In one embodiment, a consent verification is a data object that stores consent provided by a user of the verification system 150. Example components of a consent verification may include the type of personal data that may be shared, the name of the third-party system with whom the data may be shared, one or more device identifiers associated with the third-party system, a window of time or specified times at which the data may be shared, a collection period dictating which past and/or future collected data may be shared, how often the data may be shared, whether the data may be shared continuously or whether each instance of data sharing requires a new consent verification, the level of granularity at which the data may be shared, types of data that may not be shared with the third-party system, a time at which user consent was provided to the verification system 150, and a time at which the consent verification expires. The consent verification may further include data about the IoT device 120 responsible for collecting the relevant data, such as the type and model of the device 120, what type of personal data the device 120 collects, how the device 120 collects personal data, and security protocols associated with the device 120. For example, a consent verification associated with a user's insulin pump might dictate that insulin injection data collected by the pump may be shared with a third-party system 140 associated with the user's doctor on a daily basis for the next year. The consent verification might further include data about the insulin pump, including the manufacturer of the pump, the pump model, how the pump collects personal data about the user, what personal data is collected (i.e., amount of insulin injected, time of injections, blood glucose levels, etc.), and any security protocols associated with the insulin pump to prevent the unauthorized access to or tampering with the insulin pump by malicious actors.

In some embodiments, the consent verification may identify a client device 110 at which the user must be asked for permission if certain data is requested. For example, a user may provide one-time consent for workout data to be shared with the verification system 150 (e.g., forever, for the next year, etc.). However, if a third-party system 140 requests access to more sensitive health information associated with the user, the consent verification might specify that the verification system 150 should generate and send to the client device 110 a message requesting confirmation that the requested data may be shared.

In some embodiments, a consent verification may be encoded in a grammar (e.g., XACML) and/or as a set of rules (e.g., using an automation engine such as Drools or a set of Boolean operators on elements of the data description), and the grammar and/or rules may be combined with user-specified rules of precedence. For example, a user might have a consent verification specifying that the user does not share location information with a fitness tracker, but the user's immunologist might require the user's geographic information to match the geographic information with the user's outdoor information in order to understand the user's sensitivity to local allergens. In such an example, the precedence rule might specify that the provider supersedes the user when the data is requested for quality of care purposes.

In some embodiments, the data request module 220 also queries the user data store 235 for any user-specified parameters governing the storage and/or disclosure of collected information by the verification system 150. For example, user-specified parameters for data collected by IoT devices 120 associated with the user might dictate that the user's data may be stored by the verification system 150 for three years but may be shared with third-party systems 140 for only one year after the data is collected. Further user-specified parameters associated with a specific IoT device (e.g., a fitness tracker) might dictate that some of the user's activity data (e.g., steps taken, calories burned, etc.) may be shared with third-party systems 140, while other types of activity data (e.g., heart rate, pulse, etc.) may not be shared. Thus, if a third-party system 140 requests access to all activity data collected by the fitness tracker over the last two years, user-specified parameters will allow only one year of the user's steps taken and calories burned to be shared.

In one embodiment, consent verifications may provide third-party systems with the same or a lesser degree of access to the requested information than is granted to the verification system 150 by the user-specified parameters. For example, if the user-specified parameters do not permit the verification system 150 to store data collected by a wearable health tracker about a user's sleep activity, a consent verification will not permit the tracker to share with a third-party system 140 the number of hours that a user sleeps each night and the amount of time spent in various states of sleep.

If the data request module 220 determines that one or more consent verifications (and, optionally, one or more user-specified parameters) permit sharing the requested data with the third-party system 140, the data request module 220 notifies the front-end module 215 of the consent and instructs the front-end module 215 to retrieve the requested data from the user data store 235 and send the data to the third-party system 140. Alternatively, the front-end module 215 authorizes the IoT device 120 to share the requested data directly with the third-party system 140. The front-end module 215 may record instances of third-party systems 140 accessing the requested data via the verification system 150 and/or the IoT device 120 and stores the access records in the permissions data store 240, along with a timestamp of the access event, an identification of the third-party system 140, an identification of the user and the consent verification permitting disclosure to the third-party system 140, and a description of the data disclosed to the third-party system 140.

Conversely, the data request module 220 might determine that no active consent verifications permit sharing the requested data with the third-party system 140 (e.g., if the user has not consented to sharing personal data with the third-party system 140, if the consent verification associated with the collected data is expired, and/or if the level and type of data requested is not within the scope of an existing consent verification). In response, the data request module 220 notifies the consent management module 225 of the absence of a required consent verification and instructs the consent management module 225 to contact the user via the client device 110 to request permission to share the requested data with the third-party system 140.

The consent management module 225 manages consent verifications associated with data collected by an IoT device 120 and stored on the verification system 150 and determines a level and type of consent required to share collected data. For example, if the IoT device 120 is a combined medical monitoring device that collects sensitive health data, such as a user's pulse, temperature, oxygen saturation, etc., the consent management module 225 assigns a higher level of consent and thus requires a more stringent type of consent from the user to share the collected data with the user's doctor. By contrast, less sensitive data, such as the user's workout statistics (e.g., the number of miles that a user ran in the past week and the average mile time) may require a less stringent type of consent from the user. In some embodiments, the consent management module 225 maintains categories of collected information with associated levels of consent and automatically assigns a level of consent responsive to determining the type of data collected by an IoT device 120. Additionally or alternatively, a user registering an IoT device 120 with the verification system 150 may specify one or more levels of consent required to access information collected by the IoT device 120.

Responsive to receiving a request from a third-party system 140 to access data stored on the verification system 150, the consent management module 225 queries the permissions data store 235 for any consent verifications from the user associated with the requested information and/or the third-party system 140 to determine whether the consent verification has expired, whether no consent verification for the requested data exists, whether the level of consent obtained from the user is lower than the required level of consent associated with the requested data, or whether the user has not previously authorized disclosure of the requested information to the third-party system (e.g., if the user rescinded a consent verification associated with his previous doctor and has not yet granted a consent verification authorizing disclosure of medical data to his new doctor). If the consent management module 235 determines that an expired consent verification should be renewed, that a rescinded consent verification should be amended (e.g., to name a new third-party system 140), or that a new consent verification should be created, the consent management module 225 sends a consent request to the client device 110 to prompt the user to renew, amend, or create a consent verification authorizing disclosure to the third-party system 140. If the user provides a new or updated consent verification, the consent management module 225 sends the consent verification to the permissions data store 240 for storage and notifies the data request module 220 that the requested disclosure is authorized. Conversely, if the user declines or does not respond to the consent request within a specified period of time, the consent management module 220 notifies the data request module 220 that the requested data may not be shared with the third-party system.

The consent management module 225 and the front-end module 215 report consent verification data and records of third-party systems 140 accessing collected data to the distributed ledger module 230. Responsive to receiving the data, the distributed ledger module 230 periodically (e.g., hourly, daily, every 100 obtained consent verifications, etc.) appends some or all of the consent verification and access data to a distributed database or ledger (e.g., a blockchain). This period may be configurable. When an append operation is triggered (e.g., after the designated amount of time or number of obtained consent verifications), the distributed ledger module 230 verifies that the appended consent verification and access data match the data that the data reported by the consent management module 225 and the front-end module 215. If there is a mismatch, this indicates an integrity issue and corrective action may be taken (e.g., notifying the appropriate module, preventing further changes to the data, initiating data restoration from a backup, and the like). Conversely, if no data integrity issues are identified, the reported data may be appended to the distributed ledger.

In one embodiment, the distributed ledger module 230 may use a unique address for each system or application. This can increase efficiency as searching a large distributed ledger for a particular entry can be time consuming. By using a unique address, the search space can be reduced. Alternatively, the distributed ledger module 230 may serve multiple systems and/or applications and use a single address for all of the systems and/or applications it serves. Further, the distributed ledger module 230 may use multiple addresses for each user to protect the user's identity during repeated data collection and additions to the distributed ledger, reducing the risk of machine learning, network traffic, or network analysis attacks that could disclose confidential information, such as a relationship between a patient and a provider.

### Example Consent Collection Method

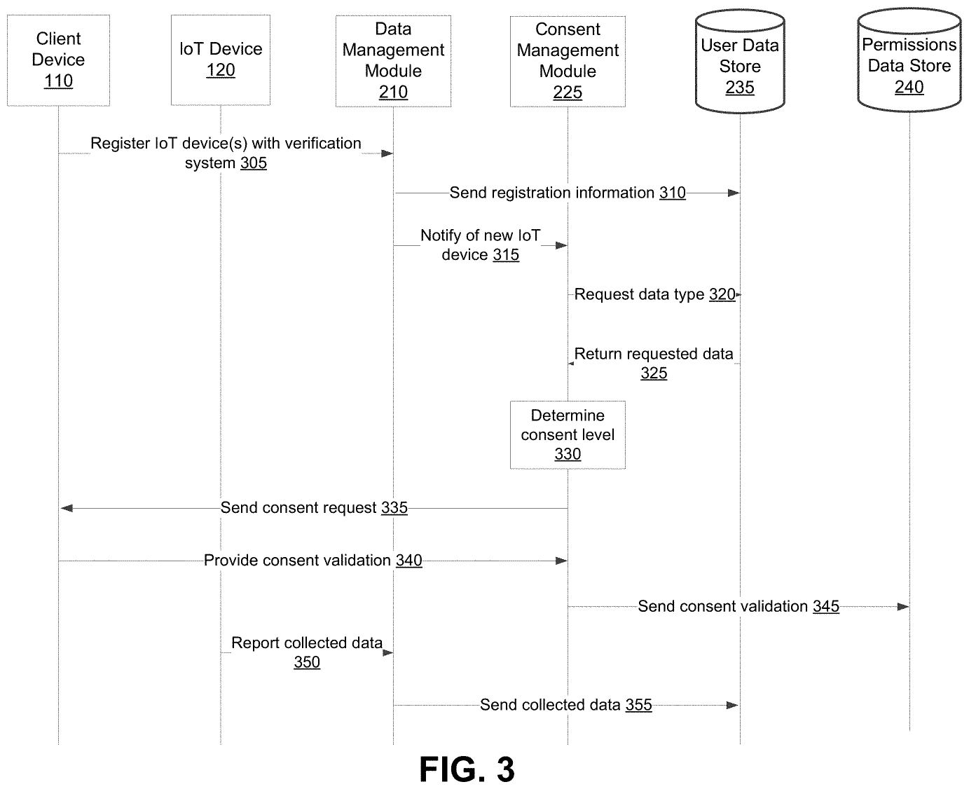

FIG. 3 illustrates an interaction diagram for obtaining consent verifications associated with data collected by an Internet-of-Things (“IoT”) device, according to one embodiment. A user uses a client device 110 to register one or more IoT devices associated with the user and the client device 110 with the verification system 150. As discussed above, the registration information may include information about the type of data collected by the IoT device 120, the way in which the data is collected, and information about the IoT device 120 itself, such as the manufacturer and model of the device 120 and security parameters associated with the device 120.

The client device 110 sends 305 the IoT device registration information to the data management module 210, which queries the user data store 235 to determine whether the user has previously created a user profile on the verification system 150. If the user has previously created a user profile, the data management module 210 sends 310 IoT device registration information to the user data store 235 for storage in the user profile. If the user is not already a user of the verification system 150 (i.e., if the user has not previously created a user profile), the data management module 210 sends a user profile creation request to the client device 110, requesting that the user provide biographic, demographic, and other types of descriptive information as well as information about the client device 110 and IoT device 120 associated with the user. User profile information may further include user-specified parameters dictating the conditions under which the verification system 150 may store and/or disclose information collected by IoT device(s) 120 associated with the user. Responsive to receiving the requested information, the data management module 210 creates the user profile and sends the profile to the user data store 235 for storage.

The data management module 210 further notifies 315 the consent management module 225 of the device registration. At 320, the consent management module 225 queries the user data store 235 for the type of data collected by the registered IoT device 120. Responsive to the user data store 235 returning 325 the requested information, the consent management module 225 determines 330 the level of consent required to share the collected information with authorized third-party systems 140. In some embodiments, one or more levels of consent may be associated with a single IoT device 120. For example, for an IoT device 120 that collects user activity and medical data from a user, the consent management module 225 might assign a high level of required consent to blood pressure and heart rate measurements collected by the IoT device 120 and a lower level of required consent to data regarding the number of steps that a user takes over a specified time period.

Responsive to determining one or more levels of consent required to allow third party systems 140 to access IoT data, the consent management module 225 sends 335 a consent request to the client device 110 to prompt the user to create one or more consent verifications associated with the collected data. The user may specify consent parameters that dictate the conditions under which a third-party system 140 may access collected data, as discussed above. In addition to consent parameters, the user may provide 340 through the client device 110 verification that the user consents to the sharing of collected data with the third-party system 140. The method of consent needed to confirm the consent verification may depend on the type of data to be shared such that disclosure of data types requiring higher levels of consent may require a more stringent method of authorization (e.g., biometric authentication) than data types for which a lower level of consent is required. The consent management module 225 sends 345 the received consent verification to the permissions data store 240 for storage in association with the user profile and the client device 110.

At 350, registered IoT devices 120 share data collected from and about the user with the verification system 150 through the data management module 210, which sends collected data 355 to the user data store 235 for storage in the user profile. Stored data may be accessed by authorized third-party systems 140 pursuant to the terms of user-specified parameters and one or more consent verifications.

### Example Access Request Processing Method

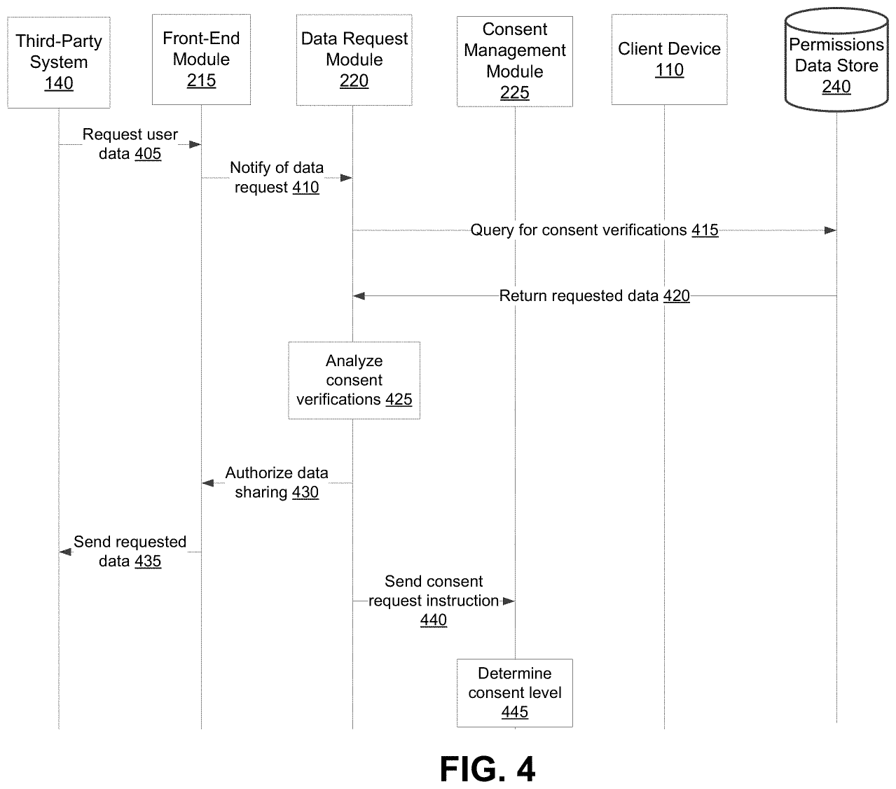

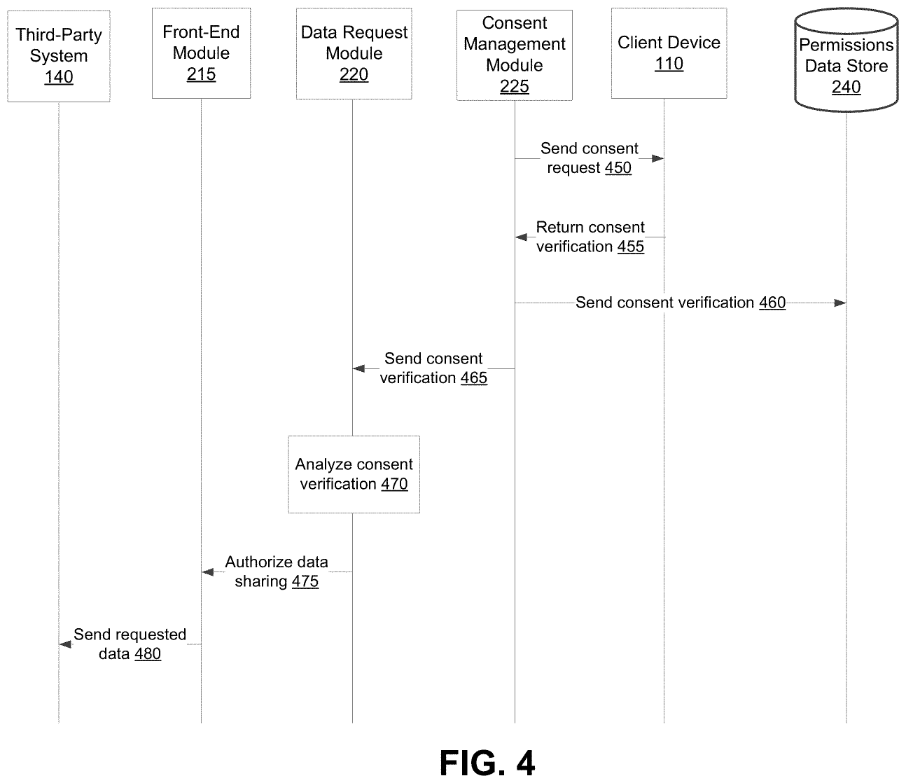

FIG. 4 illustrates an interaction diagram for processing requests from third-party systems to access data collected by an IoT device, according to one embodiment. At 405, a third-party system 140 sends 405 a data access request to the verification system 150 through the front-end module requesting access to personal data associated with the user and collected by one or more IoT devices 120. The data access request includes at least an identification of the third-party system 140, an identification of the user, an identification of one or more IoT devices 120 (e.g., an insulin pump), and a description of the requested data including a data type (e.g., blood glucose levels) and a data window (e.g., blood glucose levels measured over the last two weeks).

The front-end module 215 notifies 410 the data request module 220 of the data access request and instructs the data request module 220 to determine whether the requested data may be shared with the third-party system 140. The data request module 220 queries 415 the permissions data store 240 for one or more consent verifications associated with the requested data. Additionally, in some embodiments, the data request module 220 queries a user data store 235 for any user-specified parameters governing the storage and/or disclosure of the user's data by the verification system 150.

Responsive to the permissions data store 240 (and, optionally, the user data store 235) returning 420 the requested data, the data request module 220 determines 425 whether the data may be shared with the requesting third-party system 140. For example, the user might specify that blood pressure data collected by a combined medical monitoring device in the past six months may be shared with a third-party system associated with the user's doctor. If the user's doctor requests access to all data collected by the combined medical monitoring device over the last year, the consent verification will permit disclosure only of the user's blood pressure data collected in the past six months.

If the data request module 220 determines that some or all of the requested data may be shared with the third-party system 140, the data request module 220 authorizes 430 the front-end module 215 to share the authorized data with the third-party system 140. In one embodiment, the front end module 215 retrieves the requested data from the user data store 235 and sends 435 the data to the third-party system 140. Alternatively, the front-end module 215 instructs the IoT device 120 to send collected data directly to the third-party system 140 pursuant to the terms of the consent verification(s). In some embodiments, the requested data is encrypted or otherwise concealed before being sent to the third-party system 140. The front-end module 215 further logs records of the third-party system 140 accessing the requested information and stores the access records in the permissions data store 240.

Conversely, if the data request module 220 determines that no active consent verifications permit disclosure of the requested data to the third-party system 140 or that the consent verification(s) permit disclosure of only some of the requested data, the data request module 220 instructs 440 the consent management module 225 to send a consent request to the user via the client device 110. The consent management module 220 queries the permissions data store 240 for any consent verifications associated with the requested information and/or the third-party system 140 to determine whether an existing consent verification has expired, whether a previous consent verification was rescinded, and/or whether the user has not previously provided a consent verification for the requested data and/or for the requesting third-party system 140. The consent management module 220 further determines 445 the level and type of consent required to share the requested data based on the type of data to be shared, as discussed above with respect to FIG. 2.

At 450, the consent management module 225 sends the consent request to the client device 110 to prompt the user to renew, amend, or create a new consent verification authorizing disclosure to the third-party system 140. If the user returns 455 a new or updated consent verification, the consent management module 225 sends 460 the consent verification to the permissions data store 240 for storage and also reports 465 the consent verification to the data request module 220. At 470, the data request module 220 analyzes the consent verification to determine whether the terms of the consent verification authorize disclosure of the requested data to the third-party system 140. If the data request module 220 determines that the requested data may be shared, the data request module 220 notifies 475 the front-end module 215 of the authorization and instructs the front-end module 215 to send the requested data to the third-party system 140. In one embodiment, the front-end module 215 retrieves the data from the user data store 235 and sends 480 the data, which may be encrypted or otherwise concealed, to the third-party system 140. Alternatively, the front-end module 215 may instruct the IoT device 120 to send the data directly to the third-party system 140. The front-end module 215 logs records of the third-party system 140 accessing the requested information and stores the access records in the permissions data store 240. The consent management module 225 and the front-end module 215 further report consent verification data and records of third-party systems 140 accessing collected data to the distributed ledger module 230, which periodically appends some or all of the consent verification and access data to a distributed ledger or database to build forwarding networks for additional data sharing.

### Example Machine Architecture

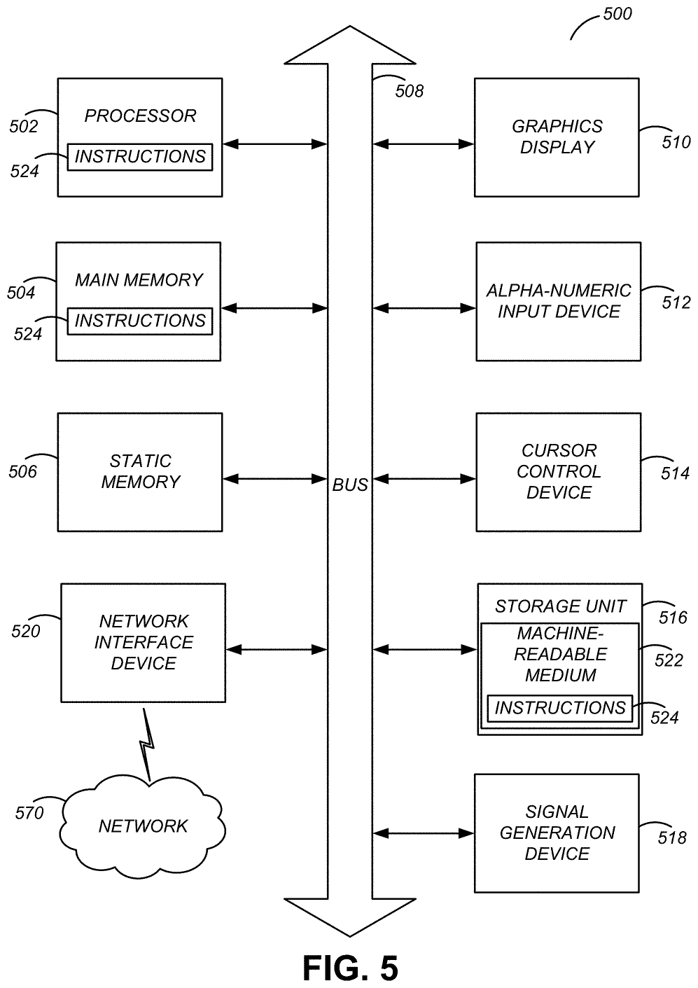

FIG. 5 is a block diagram illustrating components of an example machine able to read instructions from a machine-readable medium and execute them in a processor (or controller). Specifically, FIG. 5 shows a diagrammatic representation of a machine in the example form of a computer system 500. The computer system 500 can be used to execute instructions 524 (e.g., program code or software) for causing the machine to perform any one or more of the methodologies (or processes) described herein, including those associated, and described, with the components (or modules) of the existing client devices 110, IoT devices 120, verification system 150, or third-party system 140. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 524 to perform any one or more of the methodologies discussed herein.

The example computer system 500 includes one or more processing units (generally one or more processors 502). The processor 502 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. Any reference herein to a processor 502 may refer to a single processor or multiple processors. The computer system 500 also includes a main memory 504. The computer system may include a storage unit 516. The processor 502, memory 504, and the storage unit 516 communicate via a bus 508.

In addition, the computer system 500 can include a static memory 506, a display driver 510 (e.g., to drive a plasma display panel (PDP), a liquid crystal display (LCD), or a projector). The computer system 500 may also include alphanumeric input device 512 (e.g., a keyboard), a cursor control device 514 (e.g., a mouse, a trackball, a joystick, a motion sensor, or other pointing instrument), a signal generation device 518 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described herein. The instructions 524 may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 may be transmitted or received over a network 570 via the network interface device 520.

While machine-readable medium 522 is shown in an example embodiment to be a single medium, the term “machine-readable medium” should be taken to include a single medium or multiple media (e.g., a centralized or distributed database, or associated caches and servers) able to store the instructions 524. The term “machine-readable medium” shall also be taken to include any medium that is capable of storing instructions 524 for execution by the machine and that cause the machine to perform any one or more of the methodologies disclosed herein. The term “machine-readable medium” includes, but not be limited to, data repositories in the form of solid-state memories, optical media, and magnetic media.

### Additional Considerations

The verification system as disclosed herein provides benefits and advantages that include increased efficiency in obtaining user consent to forward data collected by Internet-of-Things devices. Storing associations between client devices and IoT devices and querying a user through a client device for consent to data sharing may allow the system to obtain authorization for disclosure of data collected by IoT devices that have fixed, limited, or no user interfaces. Furthermore, appending consent verifications and third-party system collection operations to a distributed ledger such as a blockchain may ensure that all collections of personal data were consented to be the user and that the user's personal data has not been improperly accessed. Finally, the disclosed approached may be implemented with minimal or no modification required to existing data storage systems and applications.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in FIGS. 1 through 4. Modules may constitute either software modules (e.g., code embodied on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors, e.g., 502) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 502, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for verifying data has not been tampered with through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for enforcing consent verifications for data sharing, the method comprising:
receiving, at a verification system, a request from a requesting third-party system to access data regarding a user collected by a specified wearable wireless device, the specified wearable wireless device having a limited user interface not capable of allowing the user to provide consent to data sharing;
determining, by the verification system, a required level of consent required to share the requested data with the requesting third-party system, the required level of consent based on a type of data requested by the requesting third-party system;
querying a permissions data store for one or more consent verifications associated with the requested data, each consent verification having a level of consent and permitting disclosure of data collected by a corresponding wearable wireless device to a corresponding third-party system at a corresponding level of granularity, wherein each consent verification was obtained by:
identifying the user associated with the corresponding wearable wireless device;
identifying a client device associated with the user, the client device different than the corresponding wearable wireless device;
transmitting, to the client device, a consent request specifying a corresponding type of consent associated with the level of consent; and
receiving, from the client device, authorization to share the requested data with the corresponding third-party system, the authorization obtained via the corresponding type of consent;
responsive to determining that the one or more consent verifications include a consent verification having the required level of consent and permitting disclosure of the requested data regarding the user to the requesting third-party system at a specified level of granularity, determining that the requesting third-party system is authorized to access the requested data regarding the user; and
instructing the specified wearable wireless device to send the requested data regarding the user to the requesting third-party system, the requested data being shared with the requesting third-party system at the specified level of granularity.

2. The method of claim 1, further comprising storing a record of the requesting third-party system accessing the requested data, the record including an identifier of the requesting third-party system and a time at which the requested data was accessed.

3. (canceled)

4. The method of claim 1, wherein disclosure of the requested data to the requesting third-party system is further based on user-specified parameters governing use and disclosure of the requested data by the verification system.

5. The method of claim 1, wherein authorization to share the requested data is obtained via voice command.

6. The method of claim 1, wherein the consent verification specifies a number of times that the requested data may be shared.

7. The method of claim 1, wherein the consent verification specifies a number of other third-party systems with which the requesting third-party system may share the requested data.

8. A verification system comprising:
a processor; and
a computer-readable media comprising stored instructions that, when executed, cause the processor to:
receive, at the verification system, a request from a requesting third-party system to access data regarding a user collected by a specified wearable wireless device, the specified wearable wireless device having a limited user interface not capable of allowing the user to provide consent to data sharing;
determine, by the verification system, a required level of consent required to share the requested data with the requesting third-party system, the required level of consent based on a type of data requested by the requesting third-party system;
query a permissions data store for one or more consent verifications associated with the requested data, each consent verification having a level of consent and permitting disclosure of data collected by a corresponding wearable wireless device to a corresponding third-party system at a corresponding level of granularity, wherein each consent verification was obtained by:
identifying the user associated with the corresponding wearable wireless device;
identifying a client device associated with the user, the client device different than the corresponding wearable wireless device;
transmitting, to the client device, a consent request specifying a corresponding type of consent associated with the level of consent; and
receiving, from the client device, authorization to share the requested data with the corresponding third-party system, the authorization obtained via the corresponding type of consent;
responsive to determining, that the one or more consent verifications include a consent verification having the required level of consent and permitting disclosure of the requested data regarding the user to the requesting third-party system at a specified level of granularity, determining that the requesting third-party system is authorized to access the requested data regarding the user; and
instructing the specified wearable wireless device to send the requested data regarding the user to the requesting third-party system, the requested data being shared with the requesting third-party system at the specified level of granularity.

9. The verification system of claim 8, further comprising instructions that, when executed, cause the processor to store a record of the requesting third-party system accessing the requested data.

10. (canceled)

11. The verification system of claim 8, wherein disclosure of the requested data to the requesting third-party system is further based on user-specified parameters governing use and disclosure of the requested data by the verification system.

12. The verification system of claim 8, wherein the consent verification specifies a number of times that the requested data may be shared.

13. The verification system of claim 8, wherein the consent verification specifies a number of other third-party systems with which the requesting third-party system may share the requested data.

14. A non-transitory computer-readable storage medium configured to store instructions, the instructions when executed by a processor causing the processor to:
receive, at a verification system, a request from a requesting third-party system to access data regarding a user collected by a specified wearable wireless device, the specified wearable wireless device having a limited user interface not capable of allowing the user to provide consent to data sharing;
determine, by the verification system, a required level of consent required to share the requested data with the requesting third-party system, the required level of consent based on a type of data requested by the requesting third-party system;
query a permissions data store for one or more consent verifications associated with the requested data, each consent verification having a level of consent and permitting disclosure of data collected by a corresponding wearable wireless device to a corresponding third-party system at a corresponding level of granularity; and
responsive to determining that no existing consent verification permits disclosure of the requested data to the requesting third-party system:
identify the user associated with the specified wearable wireless device;
identify a client device associated with the user, the client device different than the specified wearable wireless device;
transmit, to the client device, a consent request specifying a type of consent associated with the level of consent;
receive, from the client device, authorization to share the requested data with the requesting third-party system at a specified level of granularity, the authorization obtained via the specified type of consent;
responsive to determining that the one or more consent verifications include a consent verification having the required level of consent and permitting disclosure of the requested data regarding the user to the requesting third-party system at a specified level of granularity, determine that the requesting third-party system is authorized to access the requested data regarding the user; and
instruct the specified wearable wireless device to send the requested data regarding the user to the requesting third-party system, the requested data being shared with the requesting third-party system at the specified level of granularity.

15. The non-transitory computer-readable storage medium of claim 14, wherein the instructions further comprise instructions that, when executed, cause the processor to store a record of the requesting third-party system accessing the requested data.

16. The non-transitory computer-readable storage medium of claim 15, wherein the instructions further comprise instructions that, when executed, cause the processor to append the consent verification and the access record to a distributed ledger.

17. The non-transitory computer-readable storage medium of claim 14, wherein disclosure of the requested data to the requesting third-party system is further based on user-specified parameters governing use and disclosure of the requested data by the verification system.

18. The non-transitory computer-readable storage medium of claim 14, wherein the instructions further comprise instructions that, when executed, cause the processor to store data collected by the specified wearable wireless device according to user-specified parameters.

19. The non-transitory computer-readable storage medium of claim 14, wherein the consent verification specifies a number of times that the requested data may be shared.

20. The non-transitory computer-readable storage medium of claim 14, wherein the consent verification specifies a number of other third-party systems with which the requesting third-party system may share the requested data.

21. The method of claim 1, wherein the type of data requested by the requesting third-party system is sensitive data and wherein the specified type of consent comprises biometric identification.

22. The method of claim 1, wherein the type of data requested by the requesting third-party system is low sensitivity data and wherein the specified type of consent comprises a user-specified PIN.
